(19) United States
(12) Patent Application Publication
(10) Pub. No.: US 2007/0120345 A1
(43) Pub. Date: May 31, 2007

(54) Shipping container convertible to a trailer

(75) Inventors: John Wang, Solana Beach, CA (US); Gino Harris Granda, San Diego, CA (US)

Correspondence Address: G. L. LOOMIS & ASSOCIATES, INC., 990 HIGHLAND DRIVE, SUITE 212Q, SOLANA BEACH, CA, 92075, US

(73) Assignee: Q-Electric, LLC

(21) Appl. No.: 11/605,038

(22) Filed: Nov. 27, 2006

Related U.S. Application Data
(60) Provisional application No. 60/740,595, filed on Nov. 29, 2005.

(51) Int. Cl. B62B 5/00

(52) U.S. Cl. 280/656

(57) ABSTRACT

The present invention provides a specialized shipping container for transporting a fully assembled personal vehicle. After use, the shipping container is easily transformed into one or more alternative trailer configurations by rearrangement of the container components.

### RELATED APPLICATION DATA

This application claims priority under 35 U.S.C. § 119(e) to U.S. Provisional Application Ser. No. 60/740,595, filed Nov. 29, 2005.

### TECHNICAL FIELD

The present invention pertains generally to a shipping container for a personal vehicle, which after use, can be readily converted into a trailer that can be pulled by the vehicle.

### BACKGROUND OF THE INVENTION

Many personal vehicles, such as all-terrain vehicles (ATV), motorcycles, motor scooters, and the like, are shipped to a retailer or ultimate destination in a completely preassembled form packaged in a shipping container that protects the vehicle during transit. Examples of such shipping containers are described in U.S. Pat. No. 7,097,054 to Beck; U.S. Pat. No. 5,133,453 to Rainer; U.S. Pat. No. 6,814,529 to Junge; U.S. Pat. No. 6,726,041 to Dunn; and U.S. Pat. No. 5,593,259 to Hui-Kuei. However, after delivery, a problem arises with respect to disposal of such shipping containers and such containers are most commonly discarded or the materials from which it is fabricated are recycled. Furthermore, because of their bulk, returning such shipping containers to their source is not economically feasible, i.e. even through the containers are empty, their size assures that substantial shipping fees will be incurred and is particularly true when the vehicles are shipped long distances. For example, such vehicles are commonly shipped to North America or Europe from facilities in Asia.

To a limited extent the problem of containers disposal has been addressed through the use of cardboard for container construction. However, this solution has not proven totally satisfactory because, while cardboard is easily discarded or recycled, cardboard containers do not provide sufficient support and protection for the articles during shipping. Therefore it is highly desirable that the requisite shipping containers be fabricated from of strong rigid materials such as steel, aluminum, composites or the like to insure that the container retains shape during shipping and has sufficient strength to protect the vehicle packed therein.

Therefore, a need exists for shipping containers for fully assembled personal vehicles wherein the container can be conveniently transformed into a different useful piece of equipment. The present invention addresses this and other needs.

### SUMMARY OF THE INVENTION

The present invention discloses a specialized shipping container for transporting a fully assembled personal vehicle such as a four-wheeled all-terrain vehicle (ATV), golf cart, mobility vehicle and the like as well as a two-wheeled vehicle such as a motor cycle, motor scooter and the like. After use, the shipping container is easily transformed into one or more alternative trailer configurations by rearrangement of the container components. In preferred embodiments the resulting trailer is equipped with a standard ball mount hitch or ball receiver hitch so that it can be towed in the manner in which a standard trailer is towed by an automobile, all-terrain vehicle (ATV), two wheeled vehicle, and the like.

Essentially, the transformable shipping container comprises a flat base with a rectangular frame and a plurality of vertical cross-members, horizontal cross-members and optional diagonal cross-members; four vertical sidewalls consisting of horizontal rails and vertical rails wherein the sidewalls are removedly attachable to edges of the base frame and wherein at least one of the sidewalls is hingedly attached to an edge of the base frame; an axel and hitch sub-assembly consisting of an axel to which two wheels may be attached, at least one rail component perpendicular to the axel component and a hitch attached to the rail component, wherein the entire axel and hitch assembly is removedly attachable to underside of the base frame. The components are designed to provide for easy adjustments or modifications of both the container and trailer configurations.

The container/trailer components are fabricated from tubular metal such as tubular steel or an equivalent material and are attachable using readily available attachment means such as pins, rods, screws, bolts, eye-bolts, nuts and the like.

It should be appreciated that the principles of the present invention are not limited to the shipment of vehicles, but could also be applied to other unit goods and other aspects of the present invention will be apparent from the following detailed description, taken in view of the accompanying drawings, which illustrate, by way of example, embodiments of the invention.

### BRIEF DESCRIPTION OF THE DRAWINGS:

FIG. 1 is a top view of the disassembled individual parts of a convertible container.

FIG. 2 is an isometric view of an assembled container configuration.

FIG. 3 is an exploded isometric view of an assembled container configuration depicted

FIG. 4 is an isometric view of assembled container configuration with an all-terrain vehicle (ATV) contained therein.

FIG. 5 is an exploded isometric view of an assembled trailer configuration.

FIG. 6 is an isometric view of assembled trailer configuration towed by an all-terrain vehicle (ATV).

FIG. 7 is an isometric view of a trailer configuration with flooring on the base and tailgate.

FIG. 8 is an isometric view of a trailer configuration without tailgate and sidewalls.

FIG. 9 is an isometric view of a trailer configuration without tailgate and sidewalls showing the underside of the bed.

FIG. 10 is an orthogonal side view of a trailer configuration showing a lowered tailgate.

### DETAILED DESCRIPTION

The present invention discloses a specialized shipping container for transporting a fully assembled personal vehicle such as a four-wheeled all-terrain vehicle (ATV), golf cart, mobility vehicle and the like as well as a two-wheeled vehicle such as a motor cycle, motor scooter and the like. After use, the shipping container is easily transformed into one or more, alternative trailer configurations by rearrangement of the container components. In preferred embodiments the resulting trailer is equipped with a standard ball mount hitch so that it can be towed in the manner in which a standard trailer is towed by an automobile, all-terrain vehicle (ATV), two wheeled vehicle, and the like.

For the purposes of the present invention the terms “cross-members” and “rail” shall be interpreted as synonymous.

Essentially, the transformable shipping container for a personal vehicle of the present invention comprises:
i. a flat rectangular base frame consisting of a plurality of cross-members wherein the base is transformable into the bed of a trailer;
ii. one vertical sidewall hingedly attachable to an edge of the base frame such that it is transformable into a lowerable loading gate of a trailer configuration;
iii. three vertical sidewalls consisting of horizontal rails and vertical rails wherein the sidewalls are removedly attachable to edges of the base frame and are transformable into three retaining walls of a trailer configuration;
iii. an axel and hitch assembly consisting of an axel to which two wheels with pneumatic tires may be attached, at least one rail component perpendicular to the axel component and a hitch attached to the rail component, wherein the entire axel and hitch assembly is pivotably attachable to underside of the base frame to provide a functional trailer.

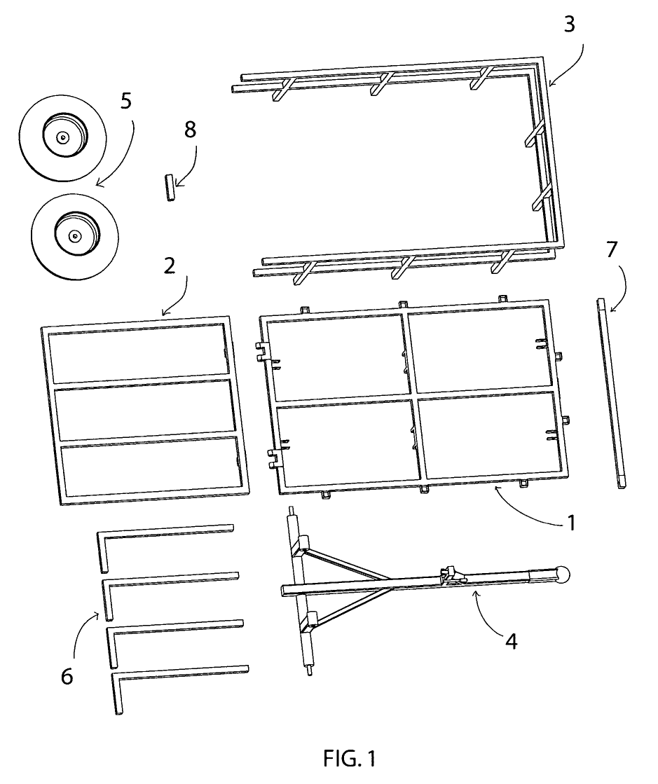

FIG. 1 illustrates the individual components of an embodiment of a container/trailer namely, a rectangular base frame 1; a hingedly attachable rectangular sidewall 2; a vertical sidewall unit 3 comprised of an three integral sidewall sections, wherein the vertical sidewall unit 3 is removedly attachable to the base frame 1; a trailer carriage (axel and hitch) assembly 4 removedly attachable to the base frame 1; two wheels 5 attachable to the carriage assembly; L-shaped extension rails 6 which function to increase the height of the vertical side wall unit 3; cargo retainer rail 7 which functions as a cargo retainer; and forklift guide 8 which is attachable to the underside of base frame 1.

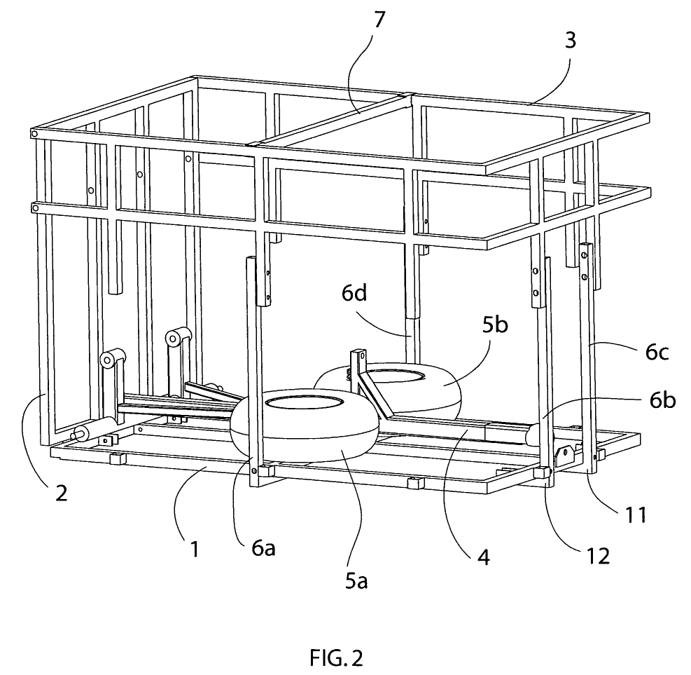

FIG. 2 depicts an embodiment of an assembled container configuration 9 comprised of the individual components illustrated in FIG. 1. In this embodiment the base frame 1 is hingedly attached to the bottom (hinged) edge of rectangular sidewall 2; vertical sidewall unit 3 is attached to the top edge (edge opposite the hinged edge) of base frame 1 and is further attached to base frame 1 by means of extension rails 6a, 6b, 6c and 6d wherein the bottom L-shaped portions 10 and 11 of extension rails 6b and 6c are positioned on the underside of base frame 1 to function as forklift guides; each end of cargo retainer rail 7 is attached to an opposing sidewall of vertical sidewall unit 3 and functions to hold cargo in place; wheels 5a and 5b as well as trailer carriage (axel and hitch) assembly 4 are situated on base frame 1 and function to hold and/or secure cargo during shipping.

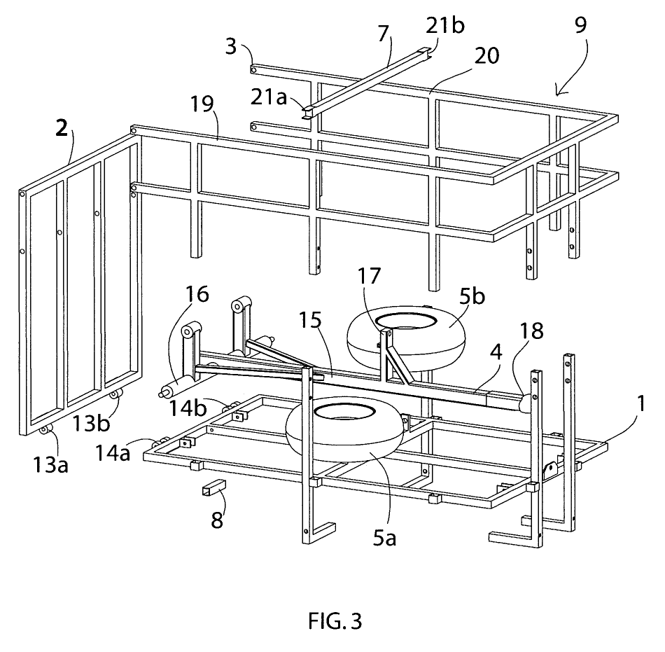

FIG. 3 is an exploded isometric view of the assembled container 9 that clearly illustrates the integral sidewall hinge components 13a and 13b, which are mated to the base frame hinge components 14a and 14b. When the container 9 is assembled, the sidewall hinge components 13a and 13b are attached base hinge components 14a and 14b with any of a variety of standard hinge pins, bolts and the like. The trailer carriage (axel and hitch) assembly 4 is comprised of a carriage rail 15, an axel 16 to which wheels 5a and 5b can be attached, a dump latch 17, and a standard size automotive-type trailer hitch 18. The forklift guide 8 attaches to the bottom of base frame 1 and the cargo retainer rail 7 is attachable to the parallel top rails 19 and 20 of the vertical sidewall unit 3. In the illustrated embodiment of FIG. 3 the cargo retainer rail 7 comprises notch ends 21a and 21b, which accommodate parallel top rails 19 and 20 of sidewall unit 3.

In the various embodiments of container configurations the individual components are fabricated with appropriately positioned holes to accept a variety of readily available standard attachment means, including but not limited to, bolts, screws, pins, latches, and the like. In preferred embodiments of container configurations, the components are attached by the use of pins or bolts (secured with nuts). In certain other embodiments of container configurations the individual components are joined through the use of screw-threaded holes and standard bolts.

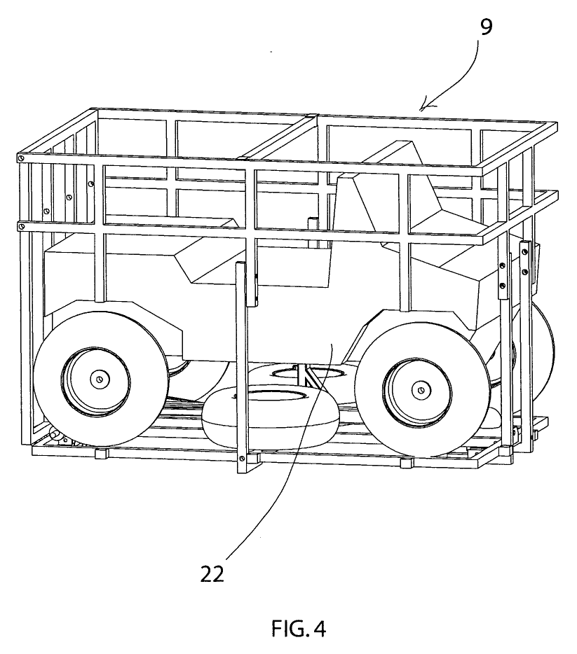

FIG. 4 is an isometric view of an embodiment of an assembled container configuration with an all-terrain vehicle (ATV) 22 contained therein.

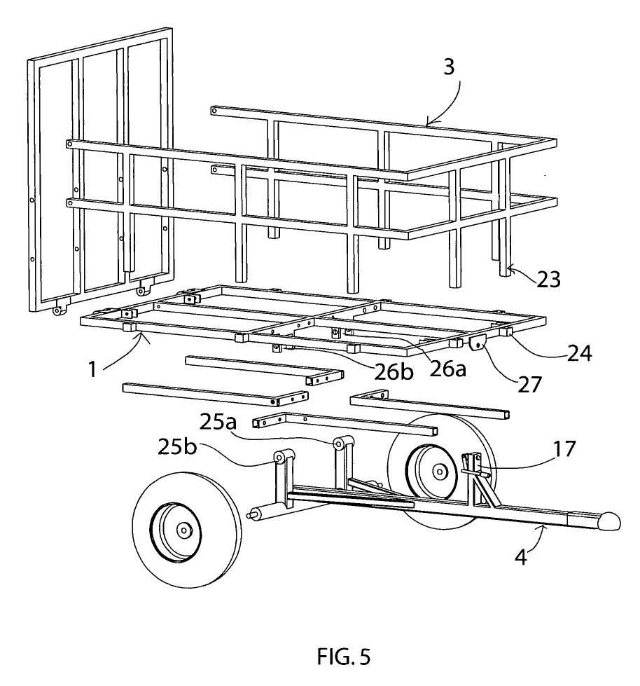

FIG. 5 depicts an exploded isometric view of an embodiment of an assembled trailer configuration. In this embodiment the vertical sidewall unit 3 is attached directly to the rectangular base 1 by insertion of the vertical rails (exemplified by vertical rail 23) of sidewall unit 3 into the receptacle sockets (exemplified by socket 24) appropriately positioned around the periphery of base frame 1. The trailer carriage (axel and hitch) assembly 4 is pivotably attached to the base frame 1 by insertion of carriage attachment components 23a and 23b into the integral U-shaped carriage acceptor components 26a and 26b of the base frame 1 and securing with two pins (not shown). The trailer carriage (axel and hitch) assembly 4 is further attached to base frame 1 by engaging the dump latch 17 and the hitch plate 27. During use as a trailer the dump latch can be disengaged allowing the trailer to pivot backwards to dump the cargo.

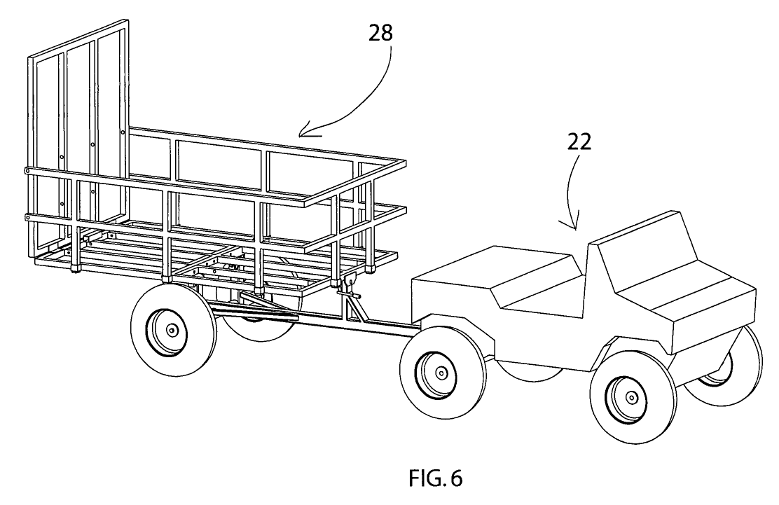

FIG. 6 shows assembled trailer configuration 28 attached to and towed by all-terrain vehicle (ATV) 22.

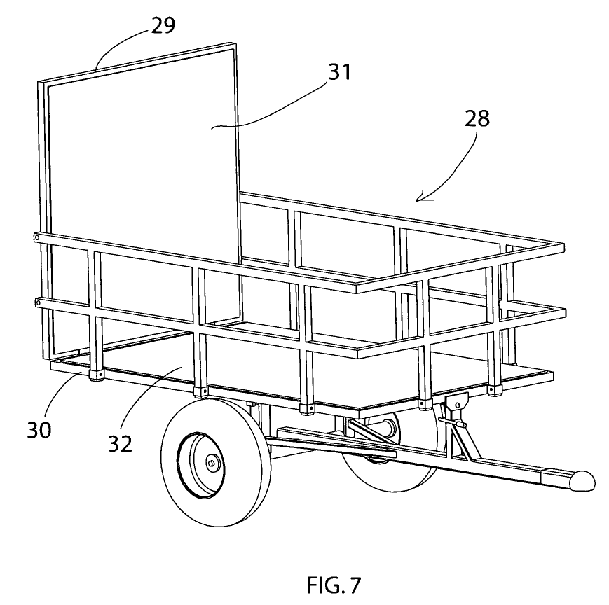

Preferred embodiments of the present invention further comprise flooring components attached to the base frame of a container configuration (trailer bed of a trailer configuration) and/or the rectangular sidewall of a container configuration (tailgate of a trailer configuration). FIG. 7 depicts the assembled trailer configuration 28 wherein a flooring component 31 is attached to the inner surface of the tailgate 29 and a flooring component 32 is attached to the top surface of the base frame 30. In certain embodiments such flooring components may be attached to any base or sidewall of either the container or trailer configurations and function to provide support for container/trailer contents as well as structural support for both the container configurations and trailer configurations. Materials for flooring components are chosen to accommodate different types of cargo. Suitable materials for flooring components include, but are not limited to, sheet metal, steel mesh, diamond deck plate, plastics, wood, composites and the like.

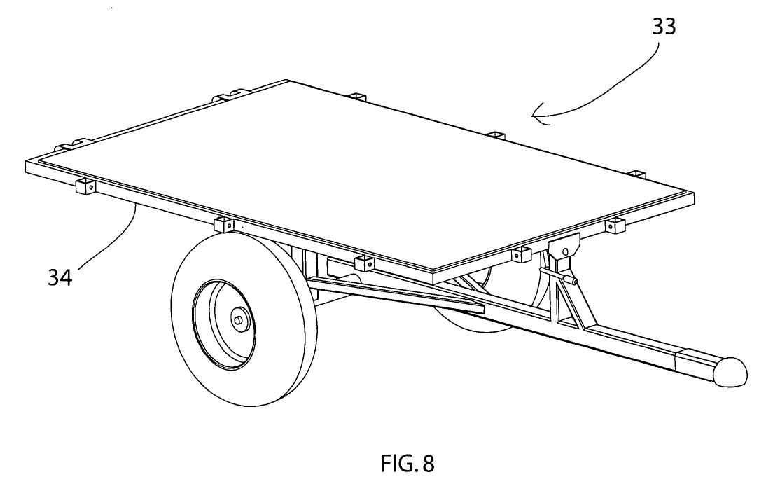

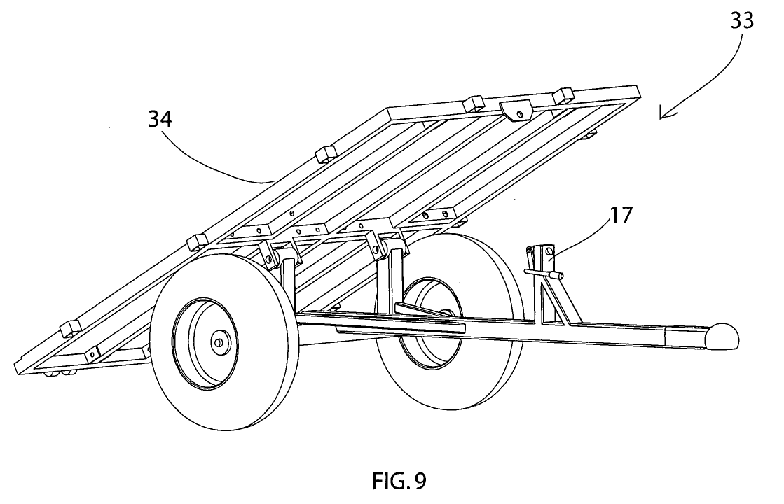

FIG. 8 depicts an embodiment of a trailer configuration 33 that utilizes only the trailer bed 34 without sidewalls or a tailgate. Such an embodiment permits transporting oversized cargo. FIG. 9 depicts the trailer configuration 33 wherein the dump latch 17 has been disengaged allowing the trailer bed 34 to pivot backward for dumping cargo.

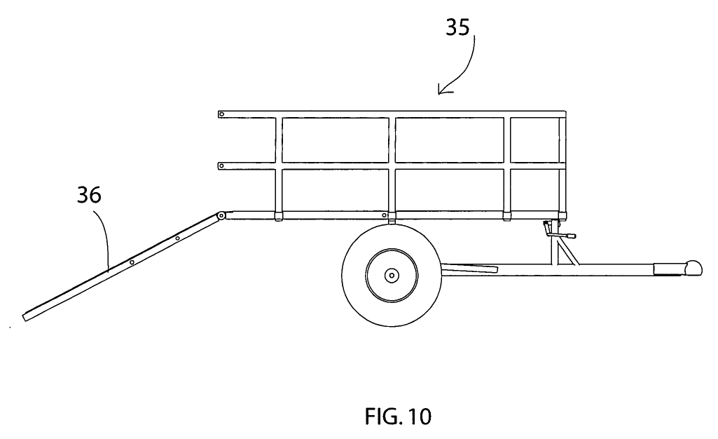

FIG. 10 illustrates an embodiment of a trailer configuration 35 wherein the hingedly attached tailgate 36 has been lowered to function as a ramp for loading or unloading cargo.

Preferred embodiments of container configurations can be stacked and can be raised from the floor, lowered to the floor or conveyed with a standard forklift. The trailer tailgate serves as a container wall when in the container configuration. During operation in the trailer configuration it may be pivotally lowered and used as a ramp for loading cargo onto the trailer bed. The trailer tailgate can be completely removed if necessary and can also be fitted with different flooring s to accommodate various cargo types.

In certain preferred container configuration embodiments the trailer wheels and axel/hitch subassembly are disposed in the bottom of the container and occupy about 10% of the volume of the container. Other preferred embodiments of the trailer configuration provides a trailer a dump feature via a dump latch which can be disengaged to tilt the trailer bed backwards for dumping cargo. In still other preferred embodiments the trailer hitch is a standard automotive size and has a lock and release lever.

In terms of operation, when in the container configuration the present invention may be used to house anything being shipped that needs protection from crushing or collision. It is a secure container capable of supporting other containers in stacked vertical relationship. When in the trailer configuration the present invention may be used for hauling any cargo which can fit into and be supported by the trailer bed.

It should be appreciated that the container and trailer configurations of the present invention may be easily inter-converted (transformed) as required. It should be further appreciated that the preferred embodiments of the invention described herein are exemplary and that numerous modifications, variations, and rearrangements will be apparent to those of ordinary skill in the art to achieve equivalent results.

We claim:

1. A shipping container transformable to trailer comprising:
a rectangular base frame that is transformable into the bed of a trailer;
a first vertical sidewall hingedly attached to an edge of the base frame and which is transformable into a lowerable loading gate of a trailer;
second, third and fourth vertical sidewalls comprised of horizontal rails and vertical rails wherein the vertical sidewalls are removedly attached to edges of the base frame and are transformable into three retaining walls of a trailer configuration;
two wheels;
an axel and hitch assembly consisting of an axel to which said two wheels may be attached, at least one rail component perpendicular to the axel component and a hitch attached to the rail component, wherein the entire axel and hitch assembly with attached wheels is pivotably attachable to underside of the base frame to provide a functional trailer.

2. The transport container of claim 1 wherein said container base frame and said first, second, third and fourth vertical sidewalls are comprised of a plurality of vertical and horizontal rails.

3. The transport container of claim 2 wherein the plurality of vertical and horizontal rails are comprised of tubular metal.

4. The transport container of claim 4 wherein said tubular metal is tubular steel.

5. The transport container of claim 2 wherein said plurality of vertical and horizontal rails further comprises diagonal cross-members.

6. The transport container of claim 1 further comprising one or more cargo retainer rails removedly attachable to at least two of said container base and said first, second, third and fourth vertical sidewalls.

7. The transport container of claim 1 wherein said second, third and fourth vertical sidewalls are an integral unit.

8. The transport container of claim 1 wherein a rigid flooring material is affixed to at least one of said container base and said first, second, third and fourth vertical sidewalls.

9. The transport container of claim 7 wherein said rigid flooring material is chosen from>the group consisting of steel mesh, sheet metal, wood, plastic, and composite.

10. The transport container of claim 8 wherein said rigid flooring material is steel mesh.

11. The transport container of claim 1 wherein said container base further comprises one or more forklift legs positioned such that the container can be lifted and conveyed with a standard forklift.

12. The transport container of claim 1 wherein said hitch is a ball receiver hitch.

13. The transport container of claim 1 wherein axel and hitch assembly comprises a dump latch.

14. The transport container of claim 1 wherein said wheels further comprise pneumatic tires.

15. The transport container of claim 1 further comprising one or more extension rails that function to increase the height of at least one sidewall.
